(19) United States
(12) Patent Application Publication
(10) Pub. No.: US 2015/0223053 A1
(43) Pub. Date: Aug. 6, 2015

(54) Enabling Learning Access on a Mobile Device

(71) Applicant: John Joseph Gillin, IV, Los Angeles, CA (US)

(72) Inventor: John Joseph Gillin, IV, Los Angeles, CA (US)

(73) Assignee: John Joseph Gillin, IV, Los Angeles, CA (US)

(21) Appl. No.: 14/171,135

(22) Filed: Feb. 3, 2014

(51) Int. Cl. H04W 8/24; H04W 84/12; H04W 4/02; H04W 88/08; G09B 7/00; G09B 5/02

(52) U.S. Cl. CPC H04W 8/24; G09B 7/00; G09B 5/02; H04W 4/02; H04W 88/08; H04W 84/12

(57) ABSTRACT

In general, embodiments of the present invention provide systems, methods and computer readable media for activating a school mode on a mobile device when the location of the device is within immediate proximity of a school. In embodiments, a learning access module is installed on a WiFi enabled device. The learning access module includes instructions that, when executed by the device, will activate a school mode on the device. School mode is a device state in which access to school services is enabled while access to one or more local services on the device is disabled. In embodiments, school mode is activated on the device when the device is within communicable range of a school wireless access point. School mode is deactivated when the device is not within communicable range of the school wireless access point.

### FIELD OF THE INVENTION

Embodiments of the invention relate, generally, to enabling a mobile device to support the learning experience of a student while the student is at school.

### BACKGROUND

It is widely recognized by educators that mobile devices (e.g., tablets, laptops, and smart phones) can provide a valuable enhancement to the student learning experience while the student is at school. For example, a student using a mobile device may leverage the interactive graphical user interface provided by applications executing on the device to receive school announcements, do work assignments, interact with the instructor, and take exams. Current methods for enabling a mobile device to support the learning experience of a student while the student is at school exhibit a plurality of problems that make current systems insufficient, ineffective and/or the like. Through applied effort, ingenuity, and innovation, solutions to improve such methods have been realized and are described in connection with embodiments of the present invention.

### SUMMARY

In general, embodiments of the present invention provide herein systems, methods and computer readable media for activating a school mode on a mobile device when the location of the device is within a predetermined proximity of a school.

In embodiments, a learning access module is installed on a WiFi enabled device, such as a tablet, laptop, mobile phone, and/or other wireless-enabled computing machine. The learning access module can be configured to include instructions that, when executed by the device, activate a school mode on the device. School mode is a device state in which access to school services is enabled while access to one or more local services on the device is disabled. In embodiments, access to school services may include execution of school-specific applications that are locally installed on the device and/or applications that are accessed via a network connection between the device and the school intranet.

In embodiments, the device can be configured to enter into and operate in school mode when the device is within a predetermined proximity of the school and/or a device associated therewith (e.g., when the device is within communicable range of a school wireless access point). The device can be configured to exit school mode when the device is not within the predetermined proximity of the school.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example scenario in which each of a group of mobile devices is configured to implement a school mode while in communicable range of a school in accordance with some embodiments discussed herein;

FIG. 2 illustrates an example system that can be configured to implement a sequence of events, at least some of which can be in response to user interactions with the system, that facilitate the establishment and maintenance of a school mode on a WiFi enabled device in accordance with some embodiments discussed herein;

FIG. 3 is a flow diagram of an example method for triggering the activation and/or deactivation of school mode on a WiFi enabled device in accordance with some embodiments discussed herein;

FIG. 4A is a flow diagram of an example method for activating school mode on a user device in accordance with some embodiments discussed herein;

FIG. 4B is a table summarizing exemplary school mode access permission profiles associated with various user roles in accordance with some embodiments discussed herein;

FIG. 5 is a flow diagram of an example method for deactivating school mode on a user device in accordance with some embodiments discussed herein; and

FIG. 6 depicts a user device, in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data may be received directly from another computing device or may be received indirectly via one or more intermediary computing devices, such as, for example, one or more servers, relays, routers, network access points, base stations, and/or the like. Similarly, where a computing device is described herein to send data to another computing device, the data may be sent directly to another computing device or may be sent indirectly via one or more intermediary computing devices, such as, for example, one or more servers, relays, routers, network access points, base stations, and/or the like.

A mobile device can be utilized as a specialized learning tool. The many advantages of interacting with a mobile device (e.g., high definition graphics, networking capabilities, powerful processors for executing complex applications) can be leveraged to enhance the learning experience of a student and thus increase the effectiveness of a teacher. However, access while at school to all of the capabilities that such a device can provide may divert or otherwise distract a student's attention from schoolwork and thus dilute the effectiveness of the mobile device as a learning tool.

It would be cost-effective for both a school and its students if each student's personal mobile device could be adapted to become a specialized learning tool only when it is located within immediate proximity of a school.

As such, and according to some example embodiments, the systems and methods described herein are therefore configured to activate a school mode on a mobile device when the location of the device is within immediate proximity of a school. In embodiments, a learning access module is installed on a WiFi enabled device. In embodiments, the learning access module is associated with a particular school and includes configuration data representing attributes of that school. The learning access module also contains configuration data representing the device and/or a particular end user of the device.

In embodiments, the learning access module includes instructions that, when executed by the device, can activate a school mode on the device. School mode is a device state in which access to school services is enabled while access to one or more local services on the device is disabled. In embodiments, access to school services may include execution of school-specific applications that are locally installed on the device and/or applications that are accessed via a network connection between the device and the school intranet. In some embodiments, access to school services may be determined by authenticating the user-identifying and/or device-identifying configuration data contained in the learning access module.

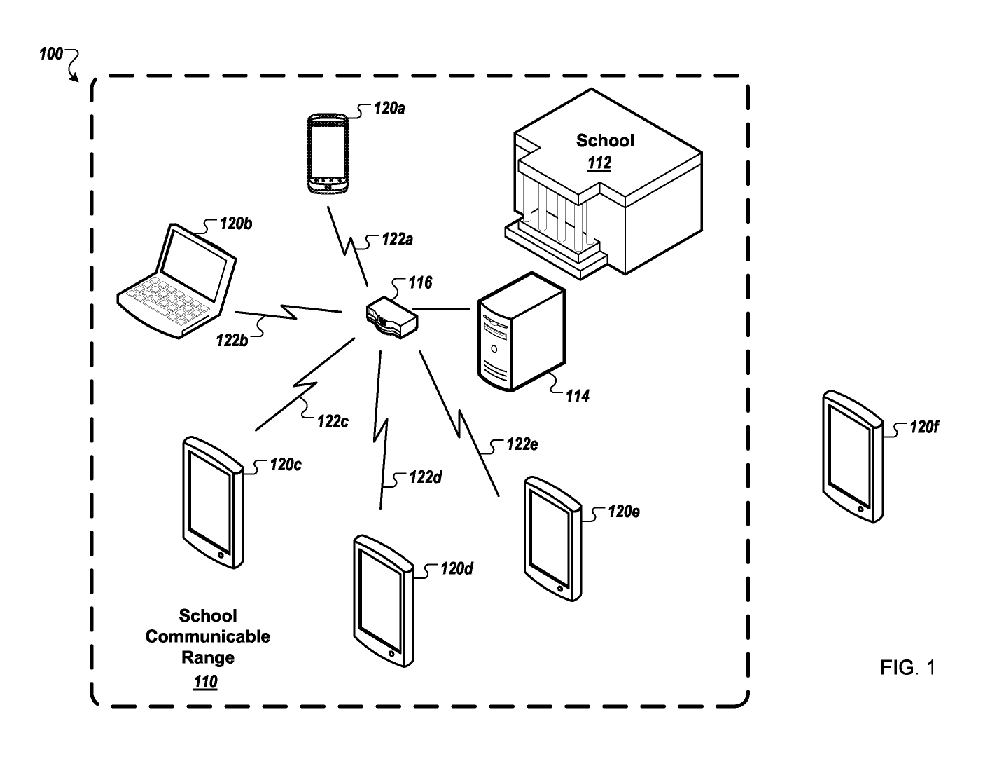

FIG. 1 illustrates an example scenario in which each of a group of mobile devices is configured to implement a school mode while in communicable range of a school.

In some embodiments, the computing facilities of a school 112 include at least one network server 114 that supports the school's internal local area network (intranet, hereinafter). The school intranet is configured to include at least one wireless access point 116 that can establish, via radio waves, a wireless computer network connection to any device that is configured to exchange data wirelessly over a computer network (WiFi enabled hereinafter) and that is within communicable range 110 of the wireless access point 116 (e.g., any of the mobile devices 120a-e and their respective wireless connections 122a-e to the wireless access point 116). A WiFi enabled device 120f that is located outside of the school wireless access point communicable range 110 cannot establish and/or maintain a wireless computer network connection with the school wireless access point 116.

In some embodiments, the school wireless access point 116 is a secure wireless access point that is configured to limit the WiFi enabled devices to which it connects by enforcing a security protocol. Conventionally, enforcement of a security protocol by a wireless access point includes receiving security data transmitted from a WiFi enabled device seeking to connect to the wireless access point, verifying the security data, and establishing the connection with the WiFi enabled device if the received security data is verified. For example, the school wireless access point 116 may require a WiFi enabled device that is seeking to connect with it to transmit a predetermined password and/or security key before it proceeds to establish a network connection with the device. Thus, in some embodiment, each WiFi enabled device that is configured to connect to the school secure wireless access point 116 can be further be configured to transmit predetermined security data to the wireless access point 116.

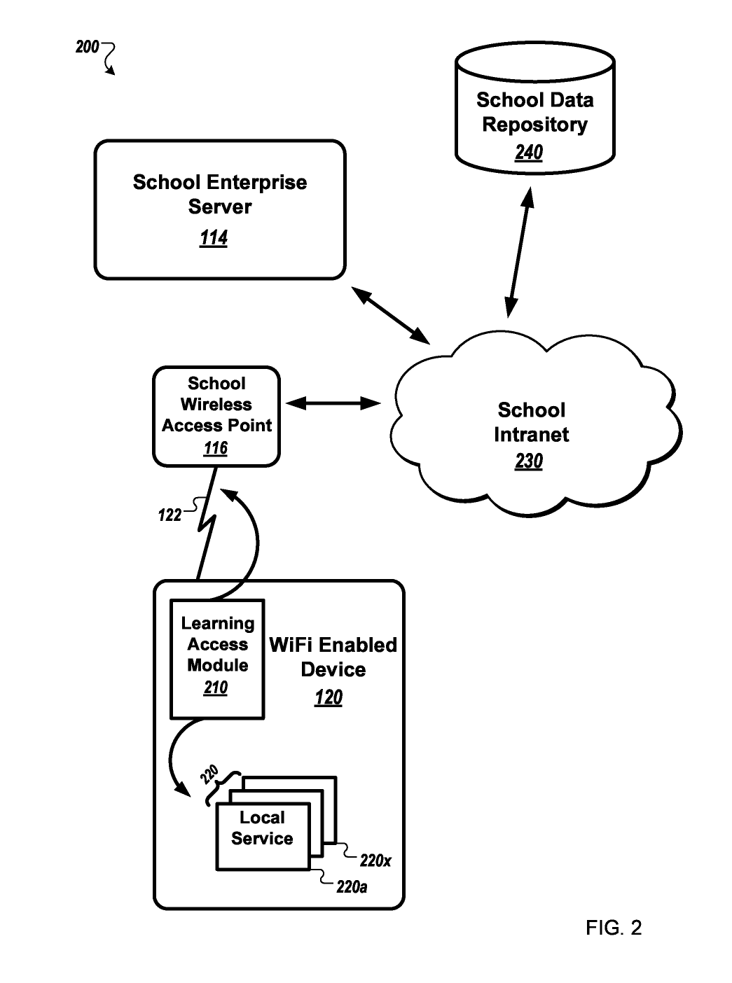

In some embodiments, each WiFi enabled device that is configured to connect to the school wireless access point also is configured to implement a school mode that is associated with a particular school 112 and is activated while the device's current geographical location is in a predetermined proximity to the school, such as within communicable range 110 of the particular school's wireless access point, within a geofence as determined by global position system coordinates, and/or any other suitable location determining approach(es). School mode is discussed in more detail below with reference to FIG. 2.

FIG. 2 illustrates an example system 200 that can be configured to implement a sequence of events, at least some of which can be in response to user interactions with the system, that facilitate the establishment and maintenance of a school mode on a WiFi enabled device 120. As referenced in FIG. 1, a WiFi enabled device can be a mobile device, e.g., a mobile phone 120a, a laptop computer 120b, or a tablet (120c, 120d, 120e, and 120f).

In some embodiments, a WiFi enabled device is a data processing device configured to include a learning access module 210 that includes instructions stored on a non-transitory computer readable media, wherein when the instructions are implemented by the device, they can cause the device to execute school mode locally. In various embodiments, learning access module 210 may be implemented as software, hardware, firmware, and/or a combination. In some embodiments, the WiFi enabled device is a mobile device, and learning access module 210 is implemented as an application (“app,” hereinafter) that is installed on non-transitory computer readable media of the device and includes instructions that can be executed by the device's processor. In some embodiments, installation of a learning access module 210 app may be preceded by downloading the app to the device via a network connection from an app source repository, e.g., a school enterprise server or a commercial app store. In some other embodiments, the WiFi enabled device may have the learning access module 210 installed as a component of the initial configuration of the device.

School mode is a device state in which access to school services is enabled while access to one or more local services 220a-x on the device is disabled. In some embodiments, school mode is activated on a WiFi enabled device 120 while the device 120 has an established connection 122 with a school wireless access point 116. In some embodiments, activation of school mode on a WiFi enabled device is triggered in response to the device establishing a connection with a particular school's wireless access point. In some other embodiments, a WiFi enabled device that is configured to include a learning access module 210 also is configured to include location functionality (e.g., the capability to determine the device's geographic position via global positioning system (GPS) and/or cellular network), and the activation of school mode on the device 120 is triggered in response to the learning access module 210 determining that the device's current geographic position is within a predetermined geographical range 110 of the school wireless access point 116. Triggering of school mode activation will be discussed in more detail with reference to method 300.

In some embodiments, a learning access module 210 includes configuration data that associates school mode with a particular school. An example of this configuration data includes a wireless network connection profile for the school wireless access point, the profile including the broadcast network address and name of the wireless access point and, optionally, the security data required for authentication of the device by the wireless access point. In various embodiments, a device 120 may be configured to include multiple learning modules 210, each learning module 210 being associated with a different school and respectively configured to execute school mode for that school.

In some embodiments, access to school services is enabled via the device's wireless connection to the school intranet 230. Once the wireless connection is established, the device 120 becomes a client device that is connected to the school intranet 230 and thus may be granted network access to school computing facilities (e.g., at least one school enterprise server 114 and/or at least one school data repository 240) as well as other to client devices (e.g., a teacher device and/or an administration device). Additionally or alternatively, one or more school services may be software and/or firmware that is installed locally on the device 120 (e.g., as locally installed apps), and activation of school mode triggers the local execution of the installed school services by the device. In some embodiments, a school service may be downloaded via the school intranet to a connected client device and then installed locally on the device. Additionally or alternatively, a school service may be installed as a component of the initial configuration of the device.

In some embodiments, the learning access module 210 configuration data may include user-identifying credentials that are provided by the device 120 to a school intranet gateway when a wireless connection from the school wireless access point 116 to the device 120 is established. In some embodiments, the user-identifying credentials may be added to the configuration data at the time that the learning access module configuration is initialized. Additionally or alternatively, in some embodiments, new or updated user-identifying credentials may be downloaded from a school service to a learning access module 210 via a network connection. In some embodiments, the learning access module 210 may provide a user interface for receiving user-identifying credentials that are input directly into the interface as a result of an interaction with a device user.

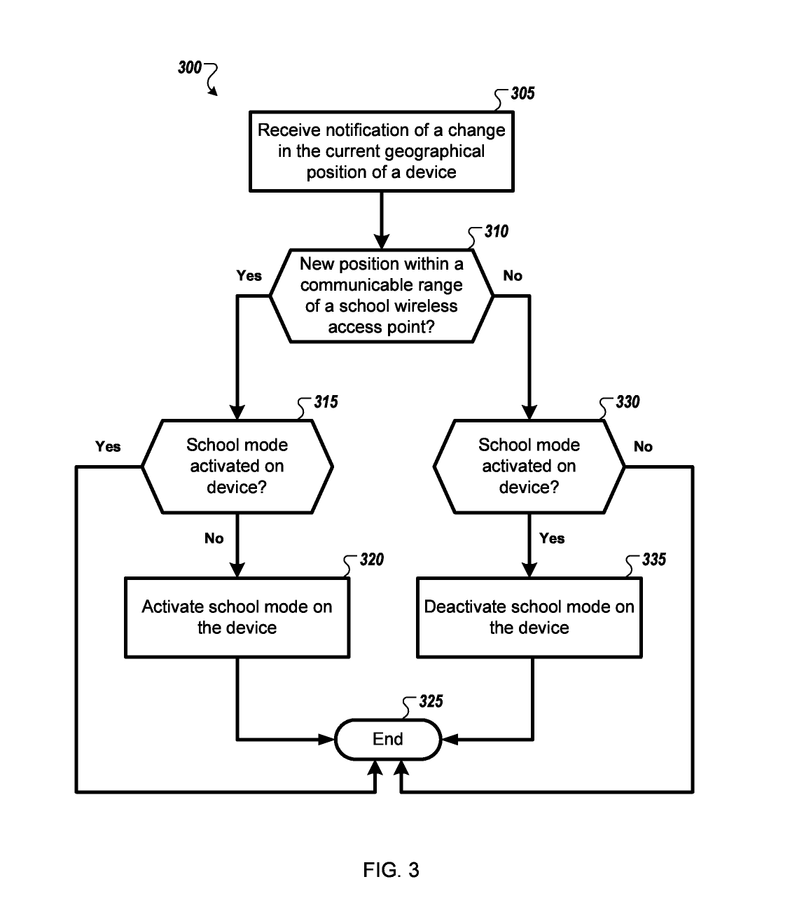

FIG. 3 is a flow diagram of an example method 300 for triggering the activation and/or deactivation of school mode on a WiFi enabled device. For convenience, the method 300 is described herein with respect to a machine system that includes one or more computing devices and performs the method 300. Specifically, the method 300 is described with respect to an example involving learning access module 210 in system 200.

The system receives at 305 a notification that the current geographical position of a WiFi enabled device has changed. The system determines at 310 whether the new geographic position is within communicable range of a school wireless access point. In some embodiments, the system is configured to determine that the device is within communicable range of the school wireless access point based on a notification from the WiFi enabled device that the school wireless access point transmission has been received. Additionally or alternatively, as previously described with respect to FIG. 2, the WiFi enabled device also may be configured to include location functionality (e.g., determine position via GPS and/or cellular network). Thus, the notification of the new position includes the new position data, and the system determines whether the device is within communicable range of the school wireless access point based on comparing the received new position data to predetermined school geographic range data that is stored in the system configuration.

In response to the system determining that the new current device position is within a communicable range of the school wireless access point, the system then determines at 315, based on its activation state data, whether school mode currently is activated on the WiFi enabled device.

In response to the system determining that the new current device position is within the communicable range of the school wireless access point and that school mode is deactivated on the device, the system is triggered (at 320) to activate school mode on the device. As previously described with reference to FIG. 2, school mode includes a device state in which access to school services is enabled by the device (wherein access to at least some of the school services is disabled when school mode is deactivated), while access to one or more local services on the device is disabled (wherein the local services are generally accessible for use when the device is operating outside of school mode).

Turning to the example system 200, triggering the activation of school mode on the device 120 can be implemented by triggering the execution of the instructions provided by the learning access module 210. In some embodiments, the device can be configured to locally trigger activation of school mode. Additionally or alternatively, the device can be configured to receive and a server (or other network component) can be configured to transmit the trigger for activation of school mode on the device 120 via the device's wireless connection 122 with the school intranet 230. The process ends at 325 once school mode is activated.

In response to the system determining that the new current device position is within the predetermined proximity of the school and that school mode is currently activated on the device, the process ends 325.

In response to the system determining that the new current device position is not within the predetermined proximity of the school and that school mode is currently activated on the device, the system is triggered (at 335) to deactivate school mode on the device. The process ends at 325 once school mode is deactivated.

In response to the system determining that the new current device position is not within the predetermined proximity of the school and that school mode is currently deactivated on the device, the process ends at 325.

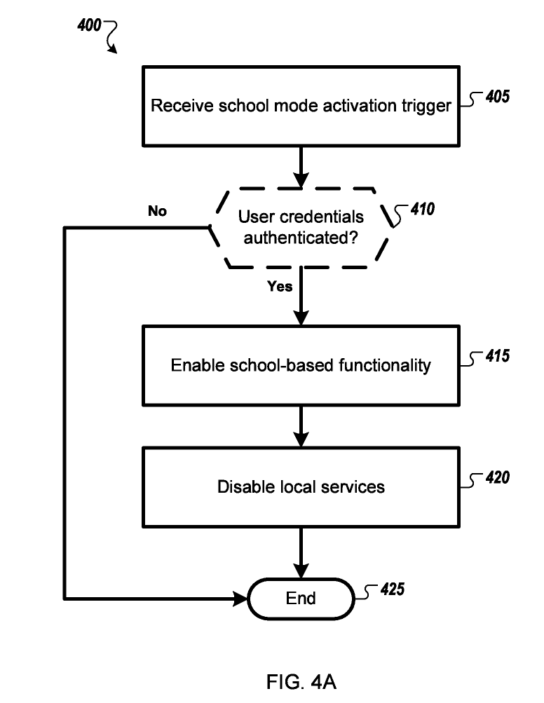

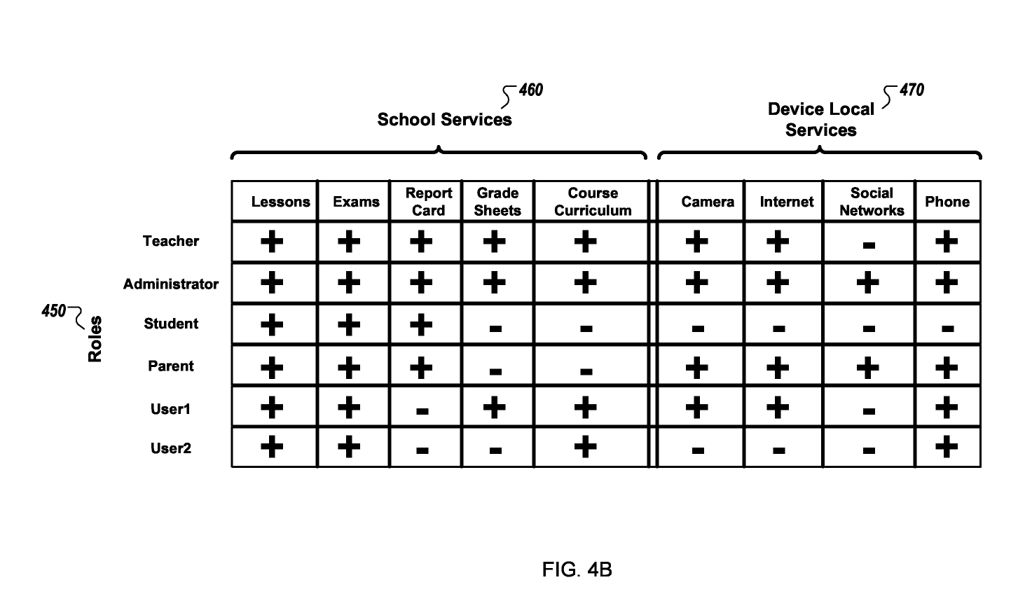

FIG. 4A is a flow diagram of an example method for activating school mode on a user device. For convenience, the method 400 is described with respect to a system that includes one or more computing devices and performs the method 400. Specifically, the method 400 is described with respect to its implementation by learning access module 210 in system 200.

In some embodiments, the system receives at 405 a trigger to activate school mode on the user device. As previously described with reference to FIG. 2, school mode is a device state in which access to at least one school service is enabled while access to one or more local services 220a-x on the device is disabled.

In some embodiments, the type and extent of access to school services through school mode may be enforced by school policies based on the identification and authentication of users. For example, a school intranet gateway may require verification of user-identifying credentials (e.g., a user identifier and a password) and/or device-identifying credentials before a device that has connected to the school wireless access point 116 can become a client device that is connected on the school intranet. Additionally, the school policy may assign a particular user to one or more different user permission categories based on the user's role at the school (e.g., teacher, administrator, student) that respectively grant different levels of access permissions to school services (e.g., a teacher and/or administrator may have access to a wider extent of services than a student can access, and students within a particular class may have access to particular services and resources only associated with that class).

Optionally, in some embodiments, the system may determine at 410 whether user-identifying credentials have been authenticated. In response to the system determining that user-identifying credentials have not been authenticated, the process ends at 425. In response to the system determining that user-identifying credentials have been authenticated, the system proceeds to activate school mode by enabling (at 415) school-based functionality and disabling (at 420) local services on the device. The process ends at 425 when school mode has been activated.

Examples of school-based functionality that may be enabled while a user device is in school mode include enabling the device to mirror data being displayed on a teacher device, enabling the device to support a student user taking a secure exam, enabling the device to generate a log of all device interactions that occur while in school mode, enabling the device to report a current location within a school to an administration device, and enabling the device to indicate an emergency in response to a school emergency system being activated.

Examples of local services 220 that may be disabled while a user device is in school mode include access to camera functionality, access to at least one type of messaging functionality, access to unauthorized social networking functionality, access to non-emergency telephone calls, the capability to turn the device power to OFF, and the capability to disable location functionality of the device.

FIG. 4B is a table summarizing exemplary school mode access permission profiles associated with various user roles. Each of the roles 450 corresponds to a user of a WiFi enabled device on which school mode is activated. The table includes a set of exemplary school services 460 and a set of device local services 470. A “+” indicates that access to a service is enabled, while a “--” indicates that access to a service is disabled.

In the example, a user assigned to a teacher role has access to all school services as well as access to almost all of the device local services (access to social networks is disabled). A user assigned the student role has access to a subset of the school services (e.g. lessons, exams, their report card) but, while school mode is activated, access to device local services is disabled. In some embodiments, a device configuration can include a pre-defined set of roles for school mode (e.g. teacher, student) as well as enable customized role definition. Turning to the example, the User1 role may be assigned to a substitute teacher, while the User2 role may be assigned to a teacher's aide.

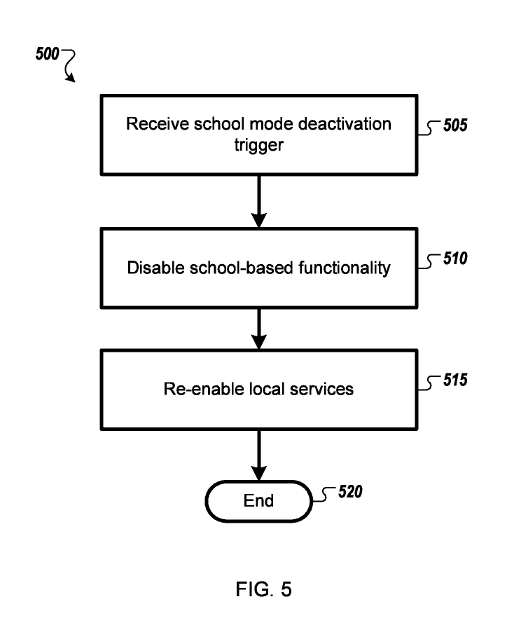

FIG. 5 is a flow diagram of an example method for activating school mode on a user device. For convenience, the method 500 is described with respect to a system that includes one or more computing devices and performs the method 500. Specifically, the method 500 is described with respect to its implementation by learning access module 210 in system 200.

In some embodiments, the system receives at 505 a trigger to deactivate school mode on the user device. As described with reference to FIG. 2, the system proceeds to deactivate school mode by disabling (at 510) school-based functionality and re-enabling (at 515) access to the local services that were disabled while school mode was activated. The process ends at 520 when school mode has been deactivated.

In some embodiments, school mode can be deactivated on the user device by triggering the learning access module 210 to execute a shutdown function.

Any such computer program instructions and/or other type of code may be loaded onto a computer, processor or other programmable apparatus's circuitry to produce a machine, such that the computer, processor, or other programmable circuitry that execute the code on the machine that creates the means for implementing various functions, including those described herein.

As described above, aspects of embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

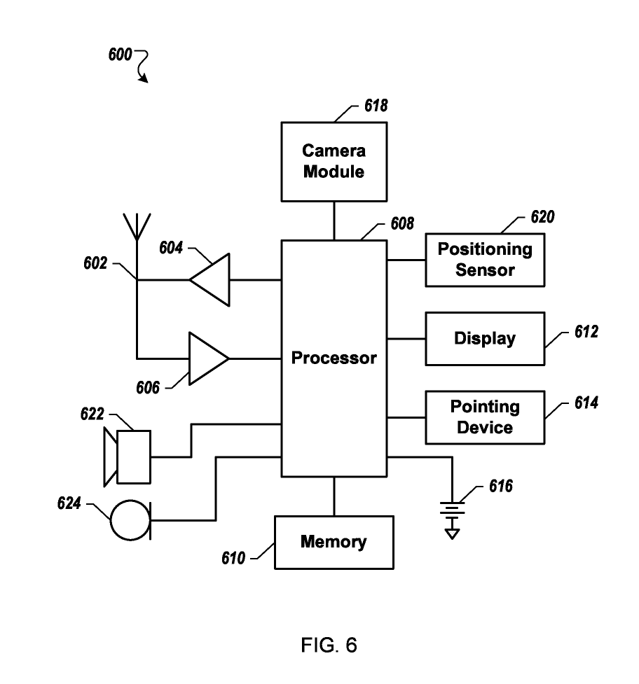

FIG. 6 depicts a user device 600 in accordance with some embodiments. While it should be understood that a mobile telephone is exemplary of one type of user device that would benefit from some embodiments of the present invention, other types of user devices, such as portable digital assistants (PDAs), laptop computers, tablets, digital cameras, and others can employ embodiments of the present invention.

As shown in FIG. 1 and further discussed elsewhere herein, user device 600 may be configured as a client device (e.g., mobile device 120) to communicate via a wireless communication network (such as a cellular network and/or a satellite network, a wireless local area network or the like) and, as such, may include one or more antennas 602 in operable communication with transmitter 604 and receiver 606. The user device 600 may further include a processor 608 that provides signals to and receives signals from transmitter 604 and receiver 606, respectively.

Processor 608 may include circuitry for implementing the functions of user device 600. For example, processor 608, such as its circuitry, may be comprised of a digital signal processor device, a microprocessor device, and various analog to digital converters, digital to analog converters, and other support circuits. Processor 608, such as its circuitry, may be configured to operate one or more software programs, such as the learning access module, which may be stored in memory 610, memory internal to the processor (not shown), external memory (such as, e.g., a removable storage device or network database), or anywhere else. For example, processor 608 may be capable of operating a connectivity program, such as a conventional Web browser. The connectivity program may allow user device 600 to transmit and receive content via a wide area network, such as the Internet, either in addition to or instead of communicating via a wireless communication network.

According to some exemplary aspects of embodiments of the present invention, processor 608 may operate under control of a computer program product. For example, the memory 610 can store one or more application programs or other software executed by the processor to control the operation of the user device, such as the learning access module. The computer program product for directing the performance of one or more functions of exemplary embodiments of the processor includes a computer-readable storage medium, such as the non-volatile storage medium (e.g., memory 610), and software including computer-readable program code portions, such as a series of computer instructions forming the learning access module, embodied in the computer-readable storage medium.

Any such computer program instructions may be loaded onto a computer or other programmable apparatus, e.g., processor 608, to produce a machine, such that the instructions which execute on the computer or other programmable apparatus (e.g., hardware) create means for implementing the above-described functions. These computer program instructions may also be stored in a computer-readable memory (e.g., memory 610) that may direct a computer or other programmable apparatus (e.g., processor 608) to function in a particular manner, such that the instructions stored in the computer-readable memory produce an article of manufacture including instruction means which implement the functions described herein (see, e.g., FIGS. 3-5). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the learning access module functions described herein.

User device 600 may comprise one or more user interfaces including output components, such as display 612 and speaker 622. The display 612 may be configured to receive touch inputs. User device 600 can also include one or more input components, such as pointing device 614, camera module 618, positioning sensor 620, microphone 624 and/or any other input component(s). The input and output components can be electrically coupled to processor 608 as shown in FIG. 6. In some embodiments, display 612 can have touch capabilities and act as both an input and output component.

User device 600 further includes a battery, solar cell(s), main power connection and/or any other power source, represented herein as power source 616, for powering the various elements that are required to operate user device 600.

In exemplary embodiments, user device 600 includes various types of specialized circuitry and other hardware that the learning access module can leverage and coordinate to solve technical problems and enhance the functionality of common devices. For example, user device 600 can include input components, such as an image capturing element, which may be a camera, in communication with the processor 608. The image capturing element may be any means for capturing an image, video or the like for storage, display or transmission. For example, in exemplary embodiments including camera module 618, camera module 618 may include a digital camera capable of forming a digital image file from a captured image. As such, camera module 618 can include all hardware, such as a lens or other optical component(s), and software necessary for creating a digital image file from a captured image. Alternatively, camera module 618 may include only the hardware needed to capture an image, while memory device 610 of user device 600 stores instructions for execution by processor 608 in the form of software necessary to create a digital image file from a captured image. In an exemplary embodiment, camera module 618 (like any other component discussed herein) may further include a dedicated processing element such as a co-processor which assists processor 608 in processing image data and an encoder and/or decoder for compressing and/or decompressing image data.

User device 600, including processor 608, may be configured to determine the context of user device 600 and, as such, may include one or more additional input components. For example, user device 600 may further include positioning sensor 620, which may be, for example, a global positioning system (GPS) module in communication with processor 608. Positioning sensor 620 may be any means, device or circuitry for locating the position of user device 600, such as by means of GPS, an assisted global positioning system (Assisted-GPS) sensor, cellular triangulation, or the like.

Microphone 624 is another example of a type of input component that may be included in user device 600. Microphone 624 can be used to receive sound and generate corresponding electrical signals.

In addition to display 612, user device 600 can include one or more other output components such as speaker 622. Speaker 622 can be used to emit audible sound.

The learning access module may be stored in memory 610 and may be accessed or executed by processor 608 to provide, among other things, the functionality described herein. The learning access module may be provided for free, for a subscription fee, for an upfront fee, or a combination thereof (e.g., some features free, some for an upfront fee and/or some for a subscription fee). When implemented on a touch screen device, some embodiments of the learning access module can enable user device 600 to provide one-touch access to school functionality and/or learning access module configuration data.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while examples involving books and multi-media applications are discussed herein, some embodiments can be configured to annotate and/or otherwise re-bundle and share any suitable type of media. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method performed by a data processing device that is operable to connect to at least one data communications network, the method comprising:
determining whether a device is within communicable range of a school wireless network access point;
in response to determining the device is in communicable range of the school wireless network access point, determining whether a school mode on the device is activated; and
in response to determining the school mode on the device is not activated, activating the school mode on the device connected to the school wireless network access point, wherein activating school mode comprises:
enabling access to at least some school services; and
disabling access to at least some local services provided by the device when the device is operating outside of the school mode.

2. The method of claim 1, further comprising:
in response to determining the device is not in communicable range of the school wireless network access point, determining whether the school mode on the device is activated; and
in response to determining the school mode on the device is activated, deactivating the school mode on the device, wherein deactivating school mode comprises:
disabling access to the school services; and
re-enabling access to the local services.

3. The method of claim 1, wherein determining whether the device is within communicable range of the school wireless network access point is based on determining that the device has received a radio transmission from the school wireless network access point.

4. The method of claim 1, wherein determining whether the device is within communicable range of a school wireless network is based on determining, using position data representing a current geographical position of the device, whether the current geographical position is within a predetermined geographical zone that includes the communicable range of the school wireless access point.

5. The method of claim 1, wherein activating school mode comprises establishing a wireless connection between the device and the school wireless access point.

6. The method of claim 5, wherein enabling access to at least some school services is based on authentication of user-identifying credentials associated with the device.

7. The method of claim 5, wherein enabling access to at least some school services comprises running one or more school-based applications that enable school-based functionality that is unavailable when the device is operating outside of the school mode.

8. The method of claim 7, wherein the school-based application is stored on the device.

9. The method of claim 7, wherein the school-based application is accessed by the device via a network connection to the school intranet.

10. The method of claim 7, wherein enabling the school-based functionality comprises at least one of:
enabling the device to mirror data being displayed on a teacher device;
enabling a user of the device to take a secure exam;
enabling the device to generate a log of all device interactions that occur while the school mode is activated;
enabling the device to report a current location within a school to an administration device; and
enabling the device to indicate an emergency in response to a school emergency system being activated.

11. The method of claim 1, wherein disabling access to at least some of the local services comprises at least one of:
disabling access to camera functionality;
disabling access to at least some types of messaging functionality;
disabling access to non-emergency telephone calls;
disabling the ability to turn OFF the device;
disabling the ability to turn OFF location functionality of the device; and
disabling unauthorized social networking functionality.

12. A computer program product, stored on a non-transitory computer readable medium, comprising instructions that when executed on one or more computers cause the one or more computers to perform operations implementing a learning access module, the operations comprising:
determining whether a device is within communicable range of a school wireless network access point;
in response to determining the device is in communicable range of the school wireless network access point, determining whether a school mode on the device is activated; and
in response to determining the school mode on the device is not activated, activating the school mode on the device connected to the school wireless network access point, wherein activating school mode comprises:
enabling access to at least some school services; and
disabling access to at least some local services provided by the device when the device is operating outside of the school mode.

13. The computer program product of claim 12, the operations further comprising:
in response to determining the device is not in communicable range of the school wireless network access point, determining whether the school mode on the device is activated; and
in response to determining the school mode on the device is activated, deactivating the school mode on the device, wherein deactivating school mode comprises:
disabling access to the school services; and
re-enabling access to the local services.

14. The computer program product of claim 12, wherein enabling access to at least some school services comprises running one or more school-based applications that enable school-based functionality that is unavailable when the device is operating outside of the school mode.

15. The computer program product of claim 14, wherein enabling the school-based functionality comprises at least one of:
enabling the device to mirror data being displayed on a teacher device;
enabling a user of the device to take a secure exam;
enabling the device to generate a log of all device interactions that occur while the school mode is activated;
enabling the device to report a current location within a school to an administration device; and
enabling the device to indicate an emergency in response to a school emergency system being activated.

16. The computer program product of claim 12, wherein disabling access to at least some of the local services comprises at least one of:
disabling access to camera functionality;
disabling access to at least some types of messaging functionality;
disabling access to non-emergency telephone calls;
disabling the ability to turn OFF the device;
disabling the ability to turn OFF location functionality of the device; and
disabling unauthorized social networking functionality.

17. A system, comprising:
a user data processing device that is operable to connect to at least one data communications network; and
a school wireless network access point, configured to connect to a school data communications network and to at least one user device; and
wherein the user data processing device is configured to perform operations comprising:
determining whether the user device is within communicable range of the school wireless network access point;
in response to determining the device is in communicable range of the school wireless network access point, determining whether a school mode on the device is activated; and
in response to determining the school mode on the device is not activated, activating the school mode on the device connected to the school wireless network access point, wherein activating school mode comprises:
enabling access to at least some school services; and
disabling access to at least some local services provided by the device when the device is operating outside of the school mode.

18. The system of claim 17, the operations further comprising:
in response to determining the device is not in communicable range of the school wireless network access point, determining whether the school mode on the device is activated; and
in response to determining the school mode on the device is activated, deactivating the school mode on the device, wherein deactivating school mode comprises:
disabling access to the school services; and
re-enabling access to the local services.

19. The system of claim 17, wherein the device comprises a tablet, a personal computer running a web browser, or a mobile telephone running a WAP browser.

20. The system of claim 17, wherein enabling access to at least some school services comprises running one or more school-based applications that enable school-based functionality that is unavailable when the device is operating outside of the school mode, and wherein at least one of the school-based applications is stored on the device.
